(19) United States
(12) Patent Application Publication
(10) Pub. No.: US 2024/0078473 A1
(43) Pub. Date: Mar. 7, 2024

(54) SYSTEMS AND METHODS FOR END-TO-END MACHINE LEARNING WITH AUTOMATED MACHINE LEARNING EXPLAINABLE ARTIFICIAL INTELLIGENCE

(71) Applicant: DATAWALK SPOLKA AKCYJNA, Wroclaw (PL)

(72) Inventors: Lukasz Laszczuk, Wroclaw (PL); Patryk Wielopolski, Wroclaw (PL); Bartosz Kolasa, Wroclaw (PL)

(21) Appl. No.: 18/471,790

(22) Filed: Sep. 21, 2023

Related U.S. Application Data
(63) Continuation of application No. PCT/EP2022/058036, filed on Mar. 26, 2022.
(60) Provisional application No. 63/166,795, filed on Mar. 26, 2021.

(51) Int. Cl. G06N 20/00

(52) U.S. Cl. CPC G06N 20/00

(57) ABSTRACT

The present disclosure provides systems and methods for end-to-end machine learning. A method of the present disclosure may comprise one or more operations of data ingestion, data preparation, feature storage, model building, and productionizing by the model. The methods and systems of the present disclosure may use an Automated Machine Learning (AutoML) algorithm and eXplainable Artificial Intelligence (XAI).

### CROSS-REFERENCE

This application is a continuation of International Application No. PCT/EP2022/058036, filed Mar. 26, 2022, which claims priority to U.S. Provisional Patent Application No. 63/166,795, filed Mar. 26, 2021, which application is entirely incorporated herein by reference.

### BACKGROUND

Machine learning is a method that can automate or provide a direction for data analysis without requiring detailed supervision or input by an operator, that is, without requiring a user to explicitly program the performance of one or more operations, to reach a prediction or outcome from the input data. The advent of machine learning technology has provided many options to analyze big data.

### SUMMARY

Many Machine Learning projects consume a significant amount of time during the model building phase, such as due to the iteration of highly repetitive activities (e.g., model selection, hyperparameter optimization, etc.). Further, it is difficult for layman (e.g., without mathematical backgrounds) to understand the processes. For instance, conventional AI algorithms may not provide sufficient explanations to the output indicative of the predictions. This may cause the information receivers, (e.g., investigators, regulators, and law enforcement people, etc.) to be skeptical about the output provided by these AI algorithms. The mis- or lack of understanding and interpretation of the models can often lead to distrust and/or model rejection. Thus, recognized herein is a need to provide extensive explanations of the models to end users. The model explanations may be provided either before deploying of the models or for monitoring during production by the models. Further recognized herein is a need to optimize model building, such as to shorten the time spent in the model building phase. Beneficially, more time can be spent on model explanation. Provided herein are methods and systems that address at least the above mentioned problems and needs.

In an aspect, provided is a computer-implemented method for end-to-end machine learning, comprising: (a) performing exploratory data analysis of a data set via a user interface presenting a visualization of a database; (b) selecting, creating, and/or engineering a feature by creating a calculated column in the dataset; (c) (i) generating and training a model using an Automated Machine Learning (AutoML) algorithm, and (ii) outputting a global explanation and a local explanation of the model based on a plurality of explanatory variables and a target variable; (d) using the visualization of the database, filtering the data set for a prediction value of the model, and generating a graphical representation of respective outcome values of one or more variables, including at least a subset of the one or more explanatory variables; and (e) subsequent to selection of a model from a plurality of models generated and trained by the AutoML algorithm, deploying the model.

In an aspect of the present disclosure, a computer-implemented method is provided for r end-to-end machine learning process. The method comprises: (a) performing exploratory data analysis of a data set via a user interface presenting a visualization of a database and identifying a plurality of explanatory variables; (b) selecting or creating a feature by creating a calculated column in the data set; (c) training a model using an Automated Machine Learning (AutoML) algorithm based at least in part on the feature in (b) and the plurality of explanatory variables; (d) outputting a global explanation and a local explanation of the model based on the plurality of explanatory variables and a target variable to determine whether to accept or reject the model; (e) upon rejecting the model, repeating (b)-(d) until a model is accepted as a production model; and (f) deploying and monitoring the performance of the production model.

In some embodiments, the visualization of the database comprises a graph with each entity class of the data set depicted as a node and connections between entity classes depicted as links. In some embodiments, the user interface provides a histogram panel displaying a histogram of an explanatory variable selected from the plurality of explanatory variables. In some embodiments, the feature is created by performing an analysis of the data set. In some cases, the analysis comprises one or more filtering operations performed on the data set. In some cases, the calculated column comprises scores produced by the analysis.

In some embodiments, the feature is created via the user interface by inputting a custom query. In some embodiments, the feature is created via the user interface by specifying a condition for assigning a value to the feature. In some embodiments, the AutoML algorithm comprises searching a plurality of available models and selecting the model based on one or more performance metrics. In some embodiments, the method further comprises using the visualization of the database, filtering the data set for a prediction value of the model, and generating a graphical representation of respective outcome values of one or more of variables, including at least a subset of the one or more explanatory variables.

In some embodiments, the global explanation comprises a reason the model provided incorrect predictions, invalid data or outliers in the data set, or extraction of knowledge about the data set. In some embodiments, the local explanation comprises model consistency across different subsets of the data set, or a contribution of one or more explanatory variables to a prediction output of the model. In some embodiments, the local explanation comprises model consistency across different subsets of the data set, or a contribution of one or more explanatory variables to a prediction output of the model. In some cases, the local explanation comprises information about how the prediction output of the model changes based on a change in the one or more explanatory variables. In some embodiments, the user interface provides a dashboard panel for monitoring and comparing the performance of the production model across time.

Another aspect of the present disclosure provides a non-transitory computer-readable medium comprising machine-executable code that, upon execution by one or more computer processors, implements any of the methods described above or elsewhere herein. In some embodiments, the method comprises: (a) performing exploratory data analysis of a data set via a user interface presenting a visualization of a database and identifying a plurality of explanatory variables; (b) selecting or creating a feature by creating a calculated column in the data set; (c) training a model using an Automated Machine Learning (AutoML) algorithm based at least in part on the feature in (b) and the plurality of explanatory variables; (d) outputting a global explanation and a local explanation of the model based on the plurality of explanatory variables and a target variable to determine whether to accept or reject the model; and (e) upon rejecting the model, repeating (b)-(d) until a model is accepted as a production model; and (f) deploying and monitoring the performance of the production model.

Another aspect of the present disclosure provides a computer system comprising one or more computer processors and a non-transitory computer-readable medium coupled thereto. The non-transitory computer-readable medium comprises machine-executable code that, upon execution by the one or more computer processors, implements any of the methods described above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “FIG.” and “FIGs.” herein).

FIG. 1 illustrates an end-to-end machine learning process workflow.

FIG. 2 illustrate an example of a visualized database and a breadcrumb.

FIG. 3 illustrates an example of a histogram generated with respect to a visualized database.

FIGS. 4-5 illustrate an example for creating features in a database by creating calculated columns.

FIGS. 6-7 illustrate an example for creating advanced features in a database.

FIGS. 8-10 illustrate an example for creating advanced features in a database based on analysis of data in the database.

FIG. 11 illustrates a feature importance plot as part of a global explanation.

FIG. 12 illustrates an output of training procedure information.

FIG. 13 illustrate an example SHapley Additive exPlanations (SHAP) summary plot as part of a global explanation.

FIG. 14 illustrates an example SHAP dot plot as part of a global explanation.

FIG. 15 illustrates an example visualization for evaluating model consistency and fairness using a visualized database.

FIG. 16 illustrates a variable breakdown plot without interactions, as part of a local explanation.

FIG. 17 illustrates a variable breakdown plot with interactions, as part of a local explanation.

FIG. 18 illustrates a SHAP average contributions plot as part of a local explanation.

FIG. 19 illustrates a Ceteris Paribus plot as part of a what-if analysis for a local explanation.

FIG. 20 illustrates a variable oscillation plot as part of a what-if analysis for a local explanation.

FIG. 21 illustrates a Fi score plot comparing two models.

FIG. 22 and FIG. 23 show an example of a database system.

FIG. 24 depicts a mind map that may represent relationships in the database of FIG. 23.

FIG. 25 shows a model of a database system.

FIG. 26 shows a computer system that is programmed or otherwise configured to apply a search path to various data models regardless of contexts.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

End-to-End Machine Learning

Systems and methods of the present disclosure provide optimizations for building predictive models as a part of an end-to-end machine learning process which utilizes Automated Machine Learning (AutoML) and Explainable Artificial Intelligence (XAI) techniques. The end-to-end machine learning process may comprise stages such as (i) data preparation, (ii) model building, and (iii) production.

At the data preparation stage, input data (e.g., raw data) may be transformed into a format suitable for model training. For example, during data preparation, the input data may be processed to perform a data integration, data quality check, data exploration, data cleaning, data transformation, and other data processing. During data preparation, feature(s) may be engineered, selected, and/or stored, and these selected feature(s) may be used for subsequent model creation.

At the model building stage, a set of actions may be iteratively implemented to create an optimized model. For example, during model building, an instance of a model may be created, evaluated, and explained for possible deploying. If a model is rejected after evaluation, a next instance of a model may be created, evaluated, and explained for possible deploying, and this process may be repeated any number of times until a model is accepted. The model building stage may comprise operations such as model training and selection, hyperparameter optimization, model evaluation, model explanation and fairness, experiment tracking, model management and storage, and other processing of the model or component (e.g., parameter) thereof.

At the production stage, the model selected during the model building stage may be deployed, and, if applicable, integrated with the relevant platform. End users may interact with the deployed model, or predictions thereof. The performance of the model may be continuously monitored, such as to ensure that the outputted prediction(s) are not biased. For example, during the production stage, operations such as model deployment, model serving, model compliance, and model validation may be performed.

As used herein, the term “training” may generally refer to a procedure in which a predictive model is created based on training datasets. A good machine learning model may generalize well on unseen data, such as to make accurate predictions at the production stage. Various techniques and algorithms can be used during training, such as any type of machine learning algorithms, architectures, or approaches. A machine learning algorithm can be implemented with a neural network. Examples of neural networks include a deep neural network, convolutional neural network (CNN), and recurrent neural network (RNN). The machine learning algorithm may comprise one or more of the following: a support vector machine (SVM), a naïve Bayes classification, a linear regression, a quantile regression, a logistic regression, a random forest, a neural network, CNN, RNN, a gradient-boosted classifier or regressor, or another supervised machine learning algorithm.

As used herein, the term “prediction” may generally refer to a procedure used for scoring unseen observations using a previously trained model.

As used herein, the terms “component,” “system,” “unit” and the like may generally refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers. Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal). As another example, a component or system can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In some cases, a component can emulate an electronic component via a virtual machine, e.g., within a cloud computing system.

In some embodiments, the methods and systems herein may provide both instance-level model explanation and dataset-level model explanation. As used herein, the term “instance-level” explanation may generally refer to a local-level explanation. An instance-level explanation may explain how and why a model yields a final score for a single observation or instance. The explanation or interpretation method of the present disclosure may be model-agnostic (e.g., applicable to neural networks, decision trees, and any type of model architecture). Model-agnostic methods of the present disclosure may highlight which variable(s) affected the final individual prediction, how strongly such variable(s) affected the prediction (e.g., variable contribution to model prediction) and to identify cause-and-effect relationships within the system's inputs and outputs. Model-agnostic methods of the present disclosure may inform how the model prediction will change if particular input variables were changed. Instance-level explanations may facilitate the assessment of model fairness, which checks if a model is biased towards a certain group based on a variable (e.g., towards any age group based on an age variable).

As used herein, the term “dataset-level” explanation may generally refer to a global-level explanation. In certain cases, it may be difficult to trace a link between an input variable(s) and a model outcome(s), which may lead to a rejection of a model. Model agnostic methods of the present disclosure may interpret any black box model, to separate explanations from the machine learning model. A dataset-level explanation may answer questions such as ‘what is the most important feature(s)?;’ ‘how will the model perform if this feature is removed?;’ and ‘is the model biased based on factors such as age, race, religion, sexual orientation, etc.?.’

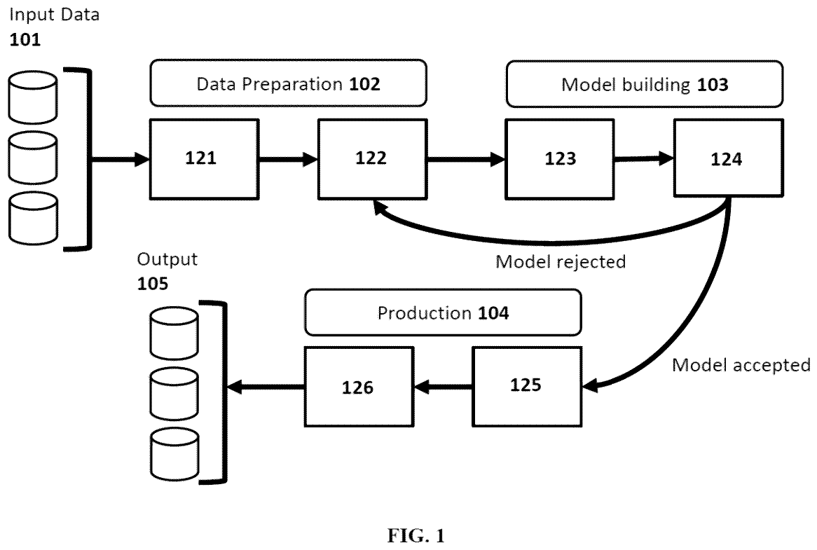

FIG. 1 illustrates an end-to-end machine learning process workflow. At the data preparation stage 102, input data 101 may be processed such as to integrate data with different sources, to perform exploratory data analysis and quality check 121 on the data. Then, the data may be processed for feature engineering and selection 122. Exploratory data analysis may comprise any suitable methods and operations such as variable identification, univariate analysis (e.g., categorical or continuous features), bivariate analysis, missing value treatment and/or outlier removal. The feature engineering and selection 122 may comprise, for example, Feature Creation (identifying the variables that will be most useful in the predictive model), Transformations (manipulating the predictor variables to improve model performance; ensuring the model is flexible in the variety of data it can ingest, ensuring variables are on the same scale, making the model easier to understand; improving accuracy; avoiding computational errors by ensuring all features are within an acceptable range for the model), Feature Extraction (extracting variables from raw data using methods such as cluster analysis, text analytics, edge detection algorithms, and principal components analysis), and Feature Selection. Conventional feature selection method may select the important independent features (e.g., explanatory variables) which have more relation with the dependent feature using the algorithms such as correlation matrix, univariate selection to analyze, judge, and rank various features to determine which features are irrelevant and should be removed, which features are redundant and should be removed, and which features are most useful for the model and should be prioritized. However, such conventional feature selection may not take into account the model interpretation and explanation results. Methods and systems herein beneficially improve features selection by incorporating the model explanation information in a seamless and intuitive manner.

At the model building stage 103, a model may be created and trained 123 based on the earlier features selected and/or engineered from the data. During this stage, methods such as automatic model and hyperparameter selection and automatic model evaluation may be used. The model may then be explained 124 at (i) the dataset-level (or ‘global-level’) such as to find the most important features, check for consistency, and build intuitions, and (ii) the instance-level (or ‘local-level’) such as to show the feature contribution (e.g., by features) for any prediction. After the model is explained, the model may be rejected or accepted. If the model is rejected, the process may retract back to feature engineering and selection 122 to change the features (or parameters thereof) and rebuild a model instance. If the model is accepted, the model may enter the production stage 104 to generate output 105. At the production stage 104, the model may perform predictions 125 and the model may be validated and explained 126. The model may be subject to automatic local-level explanations.

The workflow provided herein (e.g., with respect to FIG. 1) deviates from, and is more advantageous over, other machine learning processes which usually (1) perform an extensive search for the best model (involving model selection, hyperparameter optimization, and training) and (2) provide only a short, manual explanation or understanding of the model. In contrast, the systems and methods provided herein (1) has a much shorter model training phase (e.g., 123) by using automated tools such as Automated Machine Learning (AutoML), which can automate the operations of model selection, hyperparameter selection, optimization, and model evaluation, to significantly shorten the modeler's time consumption, and (2) provide extensive explanations (e.g., 124) by using automated dataset-level and instance-level explanation techniques, to explain the created models and ensure their fairness. Moreover, by performing the data preparation stage (e.g., 102), it is possible to extensively explore model results, not only for fairness, but also generally for all variables, including those included in the training dataset and those that were not necessarily included in the training dataset. By automating the model building phase, one can retain similar performance but save a substantial amount of time that can now be allocated to generating extensive interpretations for the model behavior.

Both global and local explanations can be provided at the model explanation 124. A global explanation may help find outliers or invalid data, for example by finding that the model is providing incorrect predictions and identifying the reason. The explanations may enable the finding of misconceptions introduced during the training operation, or if the model was trained properly, the extraction of knowledge and new conclusions about data. A local explanation may help find the respective contribution weight of different variables that lead to a final score. Furthermore, a local explanation can help determine the model consistency by investigating how the model behaves for observations from different subsets of data. The local explanation may also help determine how the model's prediction changes based on changes in one or more explanatory variables, as an what-if analysis. Interpretability techniques can be used to ensure model fairness and detect possible biases in any group (e.g., age, race, etc.). The systems and methods provided herein may provide a straightforward interface for users not familiar with mathematical theories to create better models.

### Data Preparation

Systems and methods of the present disclosure may include use of data objects. The data objects may be raw data to be processed for feature extraction, training datasets, extracted features, predictions outputted by a model and the like. A data object stored in a data structure may be linked with another data object in the same data structure or in another data structure. However, the two data objects may be related to a single abstract class. A database can be visualized as a graph with each entity class depicted as a node and connections between classes depicted as links. An interactive breadcrumb associated with an analysis or search path may be presented to a user on a user interface (UI) along with the graph. Beneficially, a visualized graph may allow a user to see a big picture of aggregated data objects in terms of abstract classes without going into the details of data objects.

The user interfaces may be displayed, for example, via a web browser (e.g., as a web page), a mobile application, and/or a standalone application. In some instances, the user interfaces shown may also be displayed on any suitable computer device, such as a cell/smart phone, tablet, wearable computing device, portable/mobile computing device, desktop, laptop, or personal computer, and are not limited to the examples as described herein. In some cases, multiple user interfaces may be switchable. A user may switch between different user interfaces than illustrated here. The user interfaces and functionality described herein may be provided by software executing on the individual's computing device, by a data analysis system located remotely that is in communication with the computing device via one or more networks, and/or some combination of software executing on the computing device and the data analysis system.

In some cases, analogous interfaces may be presented using audio or other forms of communication. In some cases, the interfaces may be configured to be interactive and respond to various user interactions. Such user interactions may include clicking or dragging with a mouse, manipulating a joystick, typing with a keyboard, touches and/or gestures on a touch screen, voice commands, physical gestures made in contact or within proximity of a user interface, and the like.

The systems and methods described herein may easily integrate many data sources and enable users to combine various data (e.g., form various sources, e.g., databases, .csv files, .xlsx files) to one data set and/or performing various other operations on the datasets for creating or updating training datasets. The data model may be used as a starting point for building the training dataset, and thus model building. Accordingly, provided herein are graphical user interfaces that allow for easy and intuitive data visualization and manipulation to improve the training dataset thereby improving the model performance.

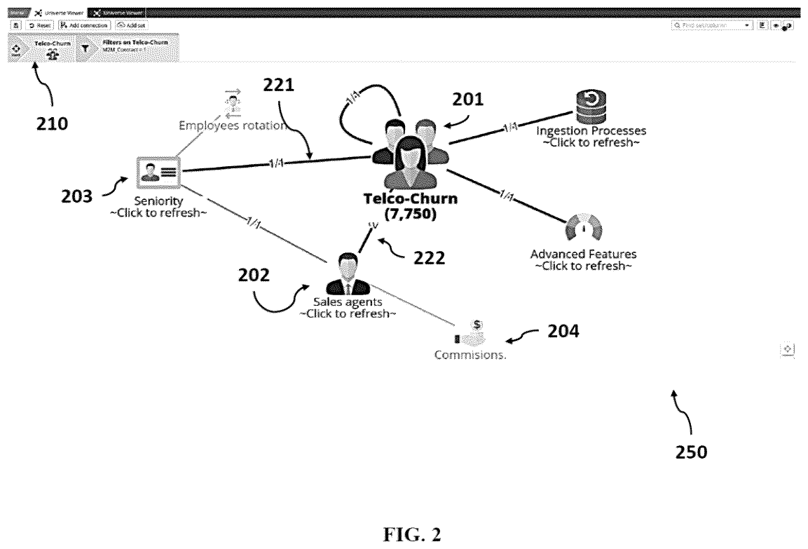

FIG. 2 shows an example of a visualized database 250 and a breadcrumb 210. Each class (e.g., “Telco-Churn”) can be visualized as a graph node. In the illustrated example, a class may include, but is not limited to, Telco-Churn 201, Sales agents 202, Seniority 203, and Commissions 204, etc. Further, such visualized classes may be interlinked. A link (e.g., link 221 between Telco-Churn 201 and Seniority 203, link 222 between Telco-Churn 201 and Sales agents 202) may be a representation of a link of underlying data objects or entities. In some applications, a link can mean a JOIN command in a database. In some cases, a visualized link may comprise an assigned link type; a link may be further associated with a meaning beyond a join. The data model illustrated in FIG. 2 may comprise data from a plurality of sources. If necessary, the data model may be further developed and updated by adding new data sets and links. Further, data subsets may be created and saved via filtering the data and creating one or more analyses. Such saved analyses or filtered data subsets can be reused at a future point in time, which may be particularly useful for tracking training data sets.

A breadcrumb 210 may be presented to a user along with the visualized database 250. The breadcrumb 210 may be generated as a user explores the database, for example, in real-time. In the illustrated example, a user may select a Telco-Churn entity class for analysis, such that a graphical element comprising a target icon and text (“Telco-Churn”) associated with the selected entity class is displayed as a first crumb of the breadcrumb 210. In some cases, a breadcrumb may start with selecting a class for investigation or analysis. Further illustrated, the user has selected only clients with month-to-month (“M2M”) contracts, which filter operation appears as a second crumb of the breadcrumb 210. The second crumb may be represented by an abstracted text description of the filter operation (“M2M_Contract=1”).

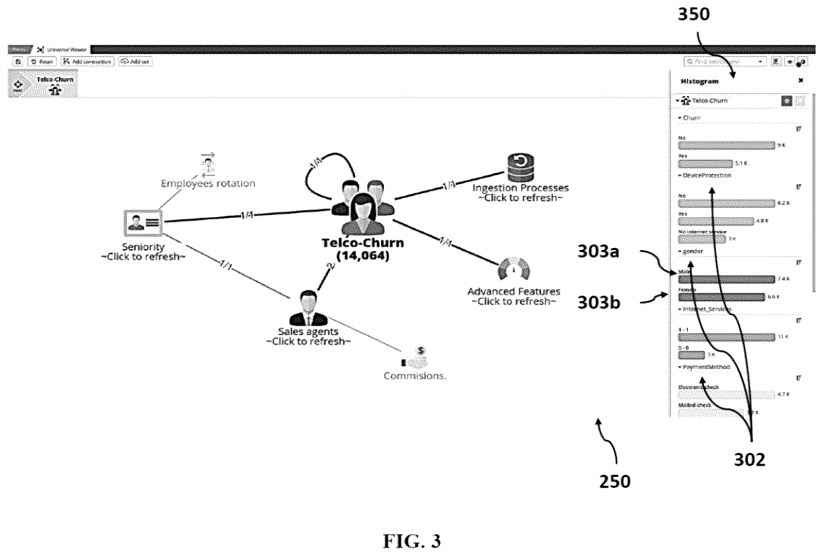

The graphical user interface may be utilized by users for feature analysis and/or features selection. FIG. 3 shows an example of a visualized database for feature analysis. A histogram panel 350 breaking down any variable 302 (e.g., “Gender”, “DeviceProtection”, “PaymentMethod”, “Internet_Services”, etc.) from the available data sets or analyses can be provided in or adjacent to the visualized database 250. The histogram panel may display a histogram of any user selected explanatory variable or feature. For example, for each variable 302 (e.g., “Gender”), the breakdown of the associated column types (e.g., “Male” 303a and “Female” 303b) can be provided. In some cases, the graphics pertaining to one variable may be presented in a first color, and the graphics pertaining to another variable may be presented in a second color different from the first one. The histogram 350 may help visualize and analyze data variables. Alternatively or in addition to the histogram, other graphical representations (e.g., pie charts, colors, texts, icons, etc.) may be presented to help visualize and distinguish the data variables.

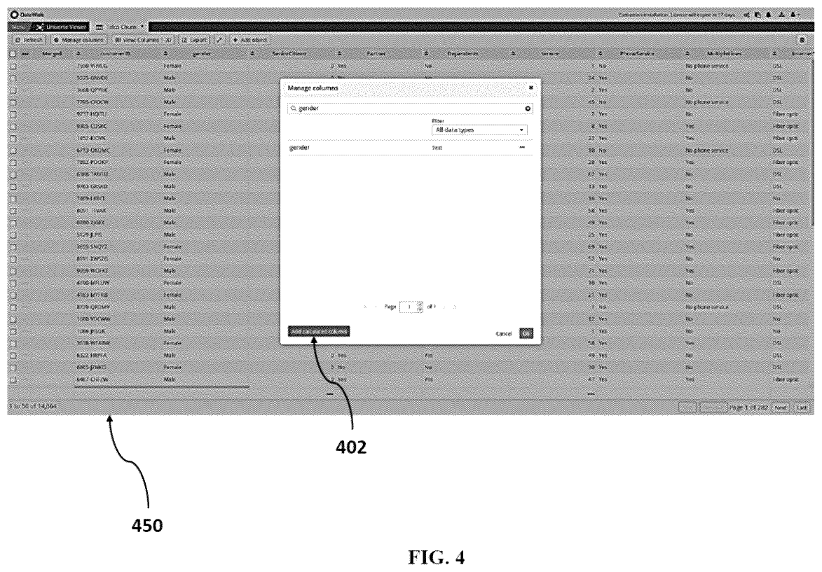

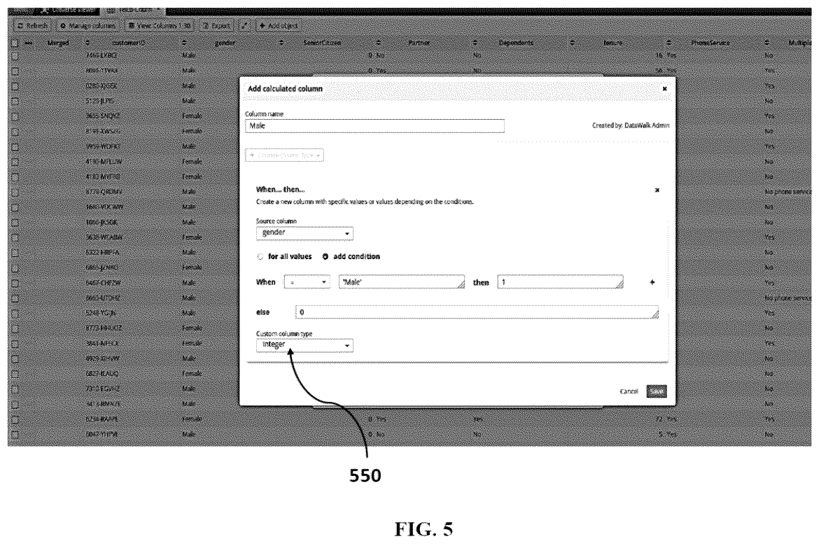

The GUI may permit users to select and/or create new features in an intuitive manner. Features may be created by creating calculated columns. A feature may be a variable (explanatory variable or independent variable). FIGS. 4 and 5 show one example for creating features in the database by adding calculated columns. With reference to FIG. 4, a table view 450 can be toggled to show the database in tabulated form, and “gender” can be dummy encoded by selecting “add calculated column” 402 under a “manage columns” option.

FIG. 5 shows an example of creating a new feature by specifying the condition for assigning a respective value (e.g., 0, 1). With reference to FIG. 5, a new column of the “When . . . then . . . ” type can be created by inputting the appropriate information in the “add calculated column” option 550. For example, the column name can be specified to “Male,” the source column, can be specified to “gender”, with the condition of “When=‘Male’ then 1, else 0” with custom column type as “Integer.” This creates a “Male” column with values 0 or 1 based on the “gender” source column.

Any created feature may be automatically recalculated to ingest new data to this data set. In some instances, such recalculation or ‘refresh’ may be manually performed, by user instructions. In some instances, the refresh may be completed periodically, automatically (e.g., every hour, every two hours, every day, every week, etc.). The user may input the frequency, or the system may use a default frequency. In some instances, the refresh may be completed every time new data is input into the system.

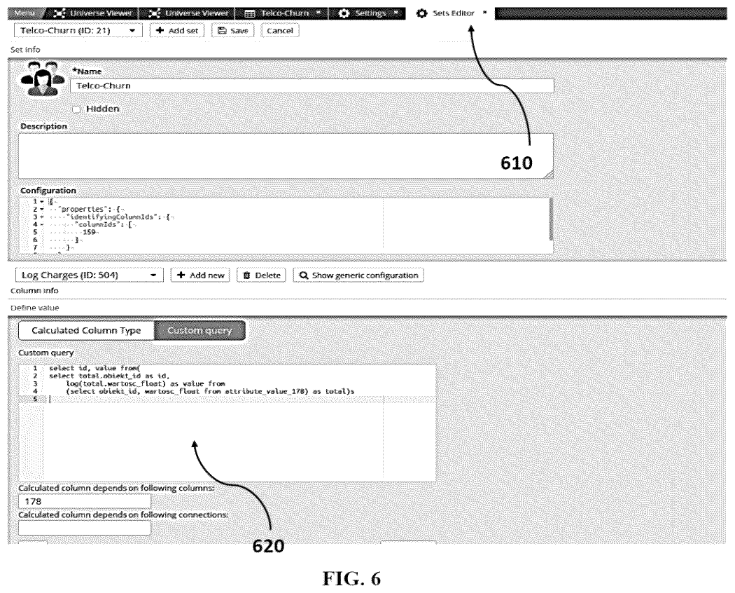

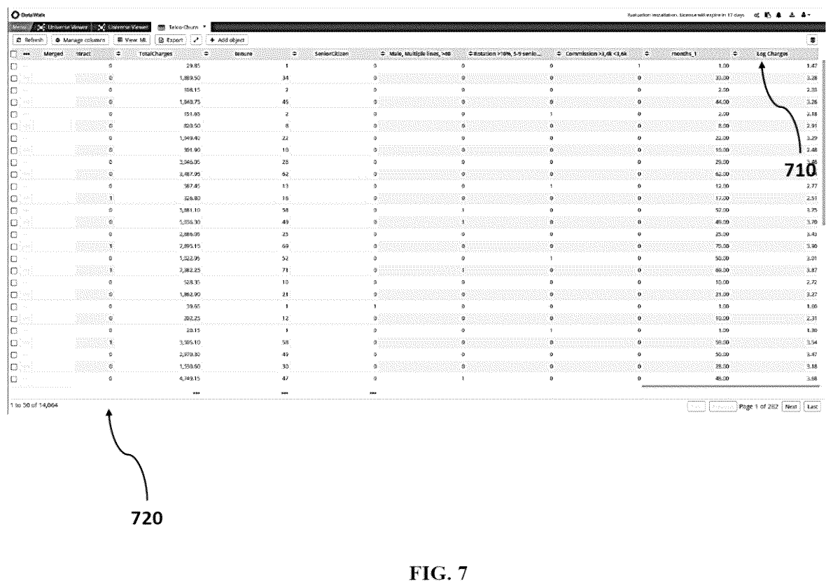

The system and method may permit users to create advanced features. More advanced features may be created by writing custom Structured Query Language (SQL) queries or using window functions. FIGS. 6-7 illustrate examples for creating an advanced feature using a custom query. Referring to FIG. 6, a “sets editor” menu 610 can be selected to bring up an interface to enter the custom query 620 (e.g., SQL query). Referring to FIG. 7, a log transformation of charge amount can be effected by the query, and a new column “Log Charges” 710 can be created, as shown in the tabulated view 720.

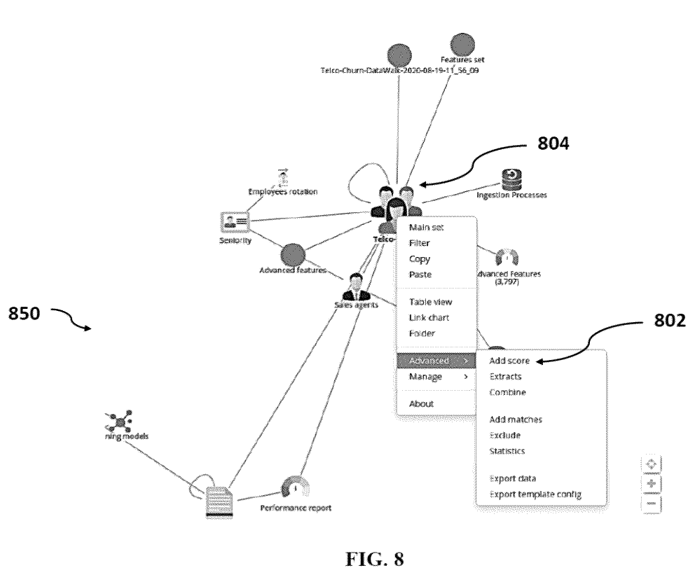

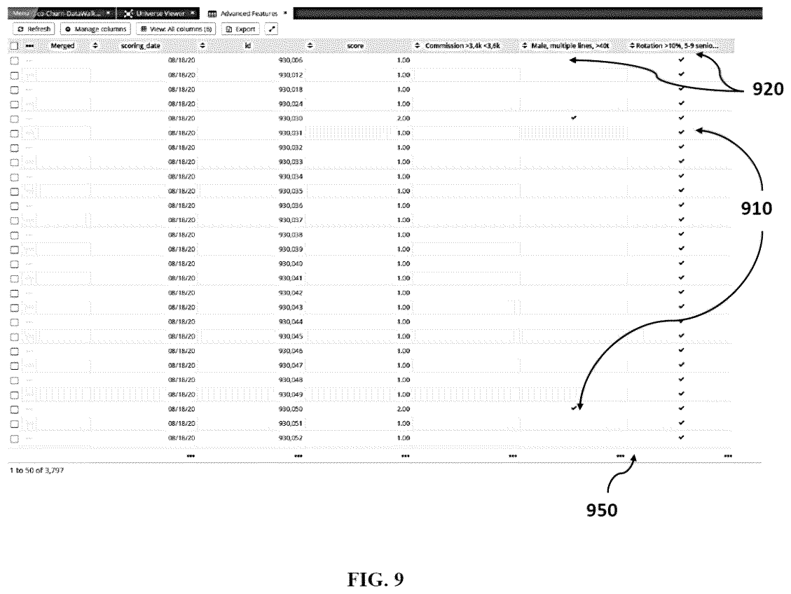

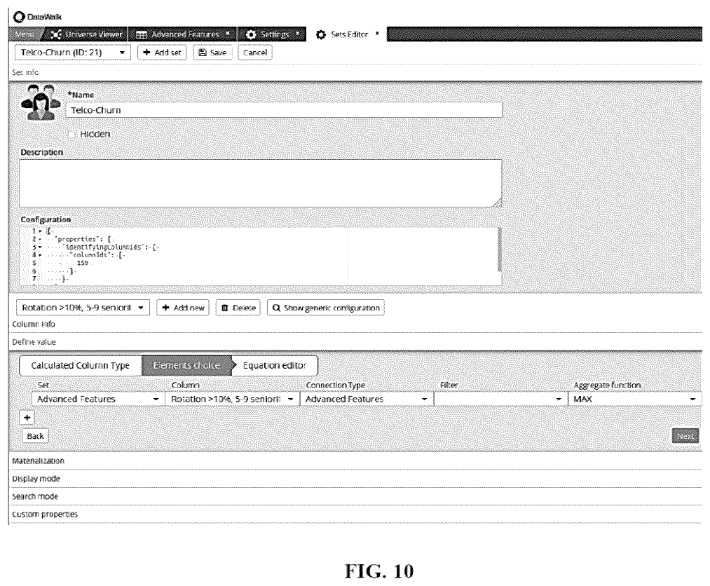

FIGS. 8-10 illustrate examples for creating an advanced feature based on analyses. The analyses may comprise one or more filter operations. Referring to FIG. 8, in the visualized database 850, a user may create an analysis by performing one or more filters and select “add score” 802 from an Advanced tab, to create scores for the analysis that will be used for the feature creation. In some cases, the scores may be used as or for generating the values for the new feature to be created. When the score is created, referring to FIG. 9, in the tabulated view 950, a dataset linked to the selected class (“Telco-Churn” 804) by ID may be created. The dataset may comprise flags 910 indicating whether one or more observations fulfills a given filter 920 (e.g., “Male, multiple lines, >40t” “Rotation>10%, 5-9 seniority”) in the analysis. Referring to FIG. 10, the flagged information may be extracted to the main data set (“Telco-Churn” 804 class) via a calculated column. In the main data set (“Telco-Churn”), a new column/feature for the filter 920 (e.g., “Rotation>10%, 5-9 seniority”) may be created. The created new feature “Rotation>10%, 5-9 seniority” may be a column of scores calculated by the analysis. The GUI as illustrated in FIG. 10 may allow users to define values of the new feature by specifying the “Set” (e.g., Advanced Features), “Column” (e.g., Rotation>10%, 5-9 seniority), “Connection Type” (e.g., Advanced Features), “Filter,” and “Aggregation” function.

### Model Building

At the model building stage, the systems and methods provided herein may implement AutoML by providing data with specified features and the target variable (dependent variable). For instance, AutoML may comprise searching a large space of available models with specific sets of hyperparameters (or other specified features) to find the model that maximizes the defined performance metric (e.g., accuracy, area under curve (AUC), area under the precision-recall curve (AUCPR)). AutoML functionality may be sourced from internal databases and/or from external libraries. For example, the systems and methods provided herein may use AutoML systems or frameworks, such as H2O AutoML, TPOT, auto-sklearn, and the like.

In an example, for churn classification, the target variable may be “Churn” and the explanatory variables may be:
“TotalCharges”,
“SeniorCitizen”,
“Male”,
“Phone_service”,
“Online_Security”,
“Online_backup”,
“Multiple_Lines”,
“Internet_Services”,
“Streaming_Movies”,
“Streaming_TV”,
“Depentents”,
“M2M_Contract”,
“OneYear_Contract”,
“TwoYear_Contract”,
“Internet_Service_Fiber_optic”,
“Internet_service_DSL”,
“Electronic check”,
“Mailed_check”,
“Bank_transfer (automatic)”,
“Credit_card (automatic)”,
“Number_of_services”,
“Male, Multiple lines, >40”,
“Rotation >10%, 5-9 seniority”,
“Commission >3.4 k <3.6 k”

The term “explanatory variables” as utilized herein may generally refer to independent or predictor variables which explain variations in the response variable (a.k.a. dependent variable, target variable or outcome variable, its value is predicted or its variation is explained by the explanatory variable). In some cases, the variables such as explanatory variable or dependent variable may be extracted from the data set.

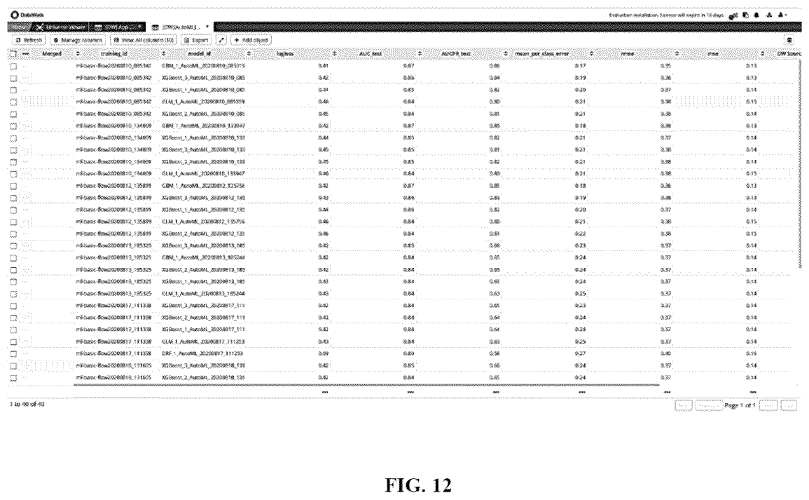

The “Churn” target variable may comprise a 0/1 flag indicating whether a client stays or leaves. After providing the above information, and running the AutoML script, the system may generate a plurality of model instances with corresponding explanations. The explanations can be used in the decision making process. The system may further output basic information about the training procedure, such as obtained scores and the hyperparameters of the models, as illustrated in FIG. 12. Data for historical models may be provided through a ‘models set’ at any point in time to facilitate transparency of the model building process.

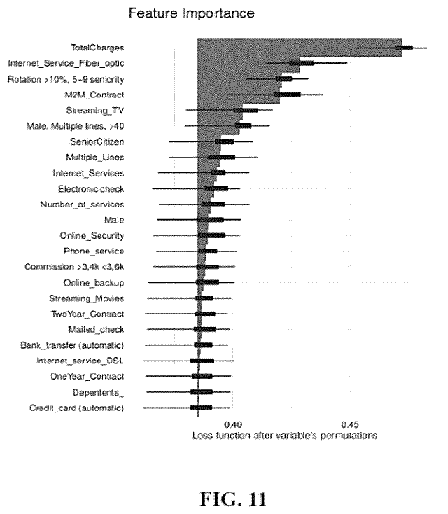

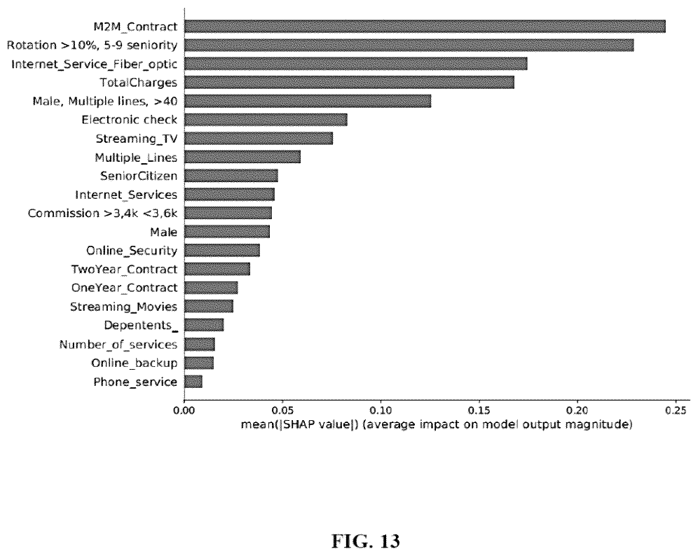

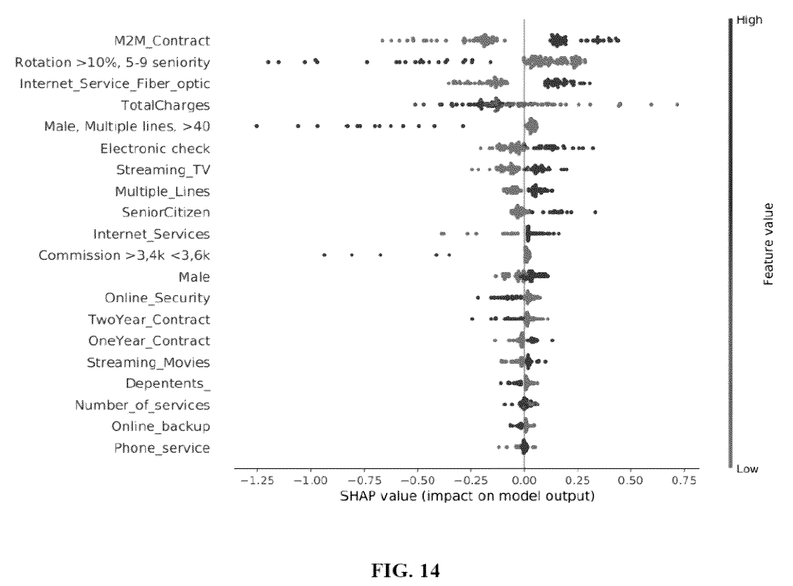

An example of a global explanation that is generated is illustrated in FIG. 11. FIG. 11 maps and sorts the feature importance for a plurality of explanatory variables by determining a loss in function after the variable's permutations (y axis showing explanatory variables, x axis showing “Loss function after variable's permutations”). The variables mapped at the top are ranked as the most important, because permuting them increases the value of loss in function (1-AUC). Feature importance may be calculated and sorted based on any defined loss function, such as logloss, RMSE, and the like. FIG. 13 illustrates an example SHapley Additive exPlanations (SHAP) summary plot, which uses SHAP values and combines feature importance with feature effect to give a broad overview of model decisions, by determining mean feature contributions to the final predictions (y axis showing explanatory variables, x axis showing mean (|SHAP value|) (average impact on model output magnitude). FIG. 14 illustrates an example SHAP dot plot analyzing each observation. The mean plot (e.g., FIG. 13) illustrates features with large absolute SHAP values as important because they contribute to the final output the most (i.e., their values bring the biggest change in comparison to a default (mean) value. The dot plot (e.g., FIG. 14) illustrates the variety of SHAP values for each observation and variable in the data set depending on the feature values, with most important features having SHAP values more distant from zero.

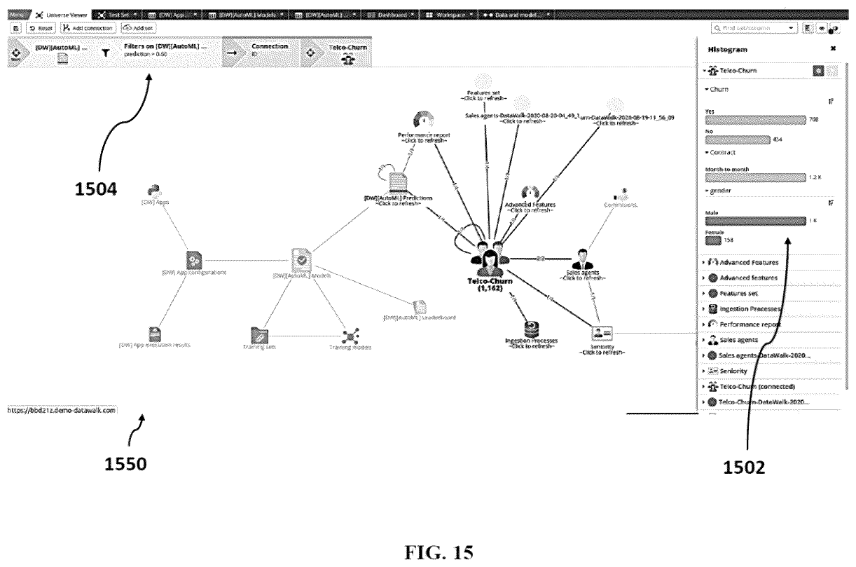

FIG. 15 illustrates a visualization of evaluating model consistency and fairness. The model consistency and fairness can be examined for any subset of the data by creating custom analyses and visualizing prediction results on the histogram. A visualized database 1550 may be used to visualize an analysis which filters positive predictions over a given threshold (e.g., 0.6 in FIG. 15) for the created models (as shown in breadcrumb 1504). The provided histogram 1502 illustrates a distribution of the outcome variable (e.g., “Churn”) and explanatory variables (e.g., “Contract” and “gender”). In this example, it is easily readable from the histogram 1502 that all positive predictions are “month-to-month contracts” within the “Contract” explanatory variable, possibly indicating bias for month-to-month contracts, and that a high percentage of the positive results are skewed towards “male” than “female” within the “gender” explanatory variable. Such information may prompt the user to investigate these variables, if it is important that the model does not make predictions based on factors (i.e., variables) such as gender. In some cases, such information may be utilized to calibrate the model to improve the correctness of the output result. Any other variable, not necessarily included in the training dataset, may be analyzed for consistency and fairness of the model outcome.

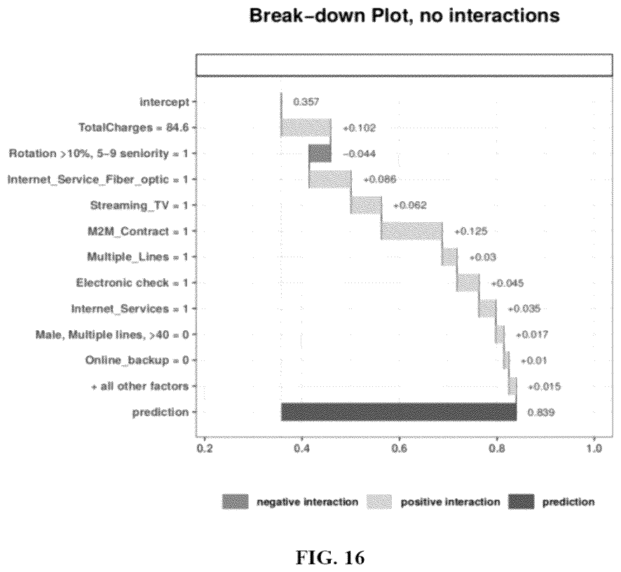

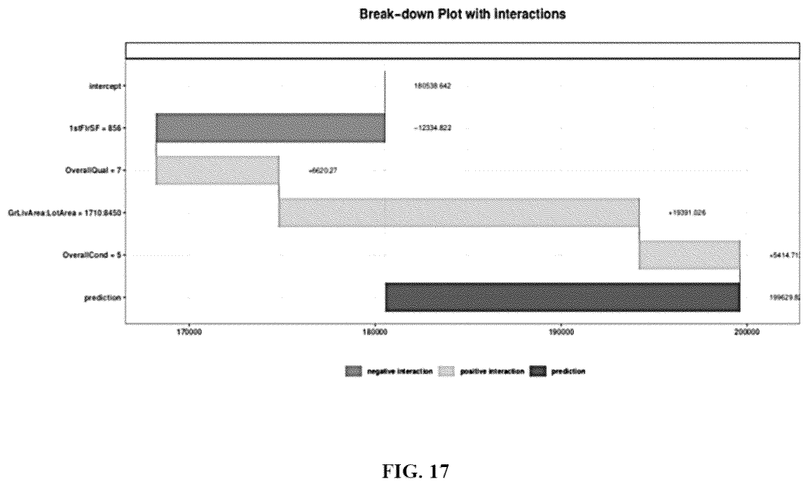

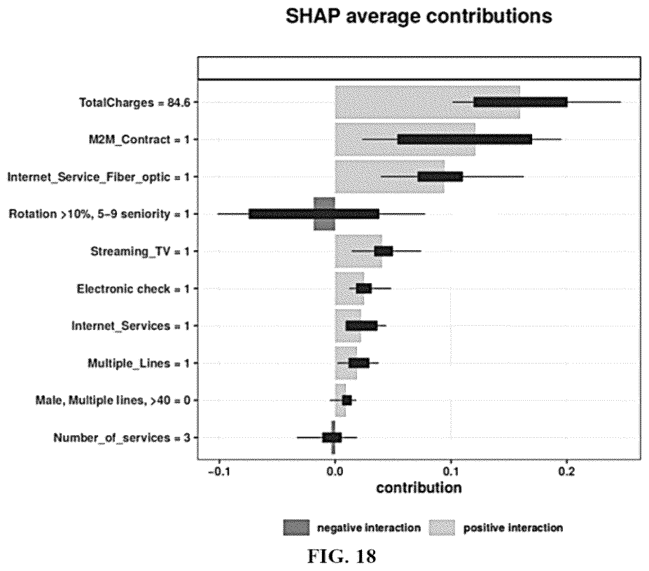

Instance-level (local) explanations may also be generated. The system may provide local explanations in a GUI. FIG. 16 illustrates a variable breakdown plot without interactions, and FIG. 17 illustrates a variable breakdown plot with interactions. The variable breakdown plot without interactions of FIG. 16 illustrates the contribution of each variable to the final prediction without considering possible interactions. In the legend below the chart, the shades of color depict, in order of left to right, negative interaction, positive interaction, and prediction. The variable breakdown plot with interactions of FIG. 17 illustrates the contribution of each variable to the final prediction, including the consideration of possible interactions. In the legend below the chart, the shades of color depict, in order of left to right, negative interaction, positive interaction, and prediction. In this example (which shows a different problem than the ‘churn classification’ problem illustrated in FIG. 16), the third contribution contains a quotient of two variables: “GrLivArea′ and ‘LotArea’ which highly influenced the model decision. FIG. 18 illustrates the SHAP average contributions as a local explanation. The SHAP plot describes the contribution of each variable to the final prediction calculated using SHAP values. In the legend below the chart, the shades of color depict, in order of left to right, negative interaction (contribution) and positive interaction (contribution). The plot illustrates an average breakdown plot for n random orderings of variables. The darkest boxes in the map illustrate the distribution of the contributions for each explanatory variable across used orderings. High values of ‘contribution’ (on x axis)” indicate the importance of a variable.

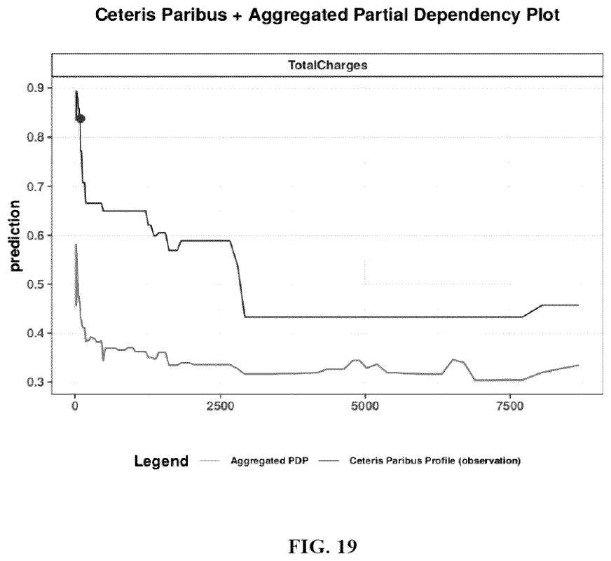

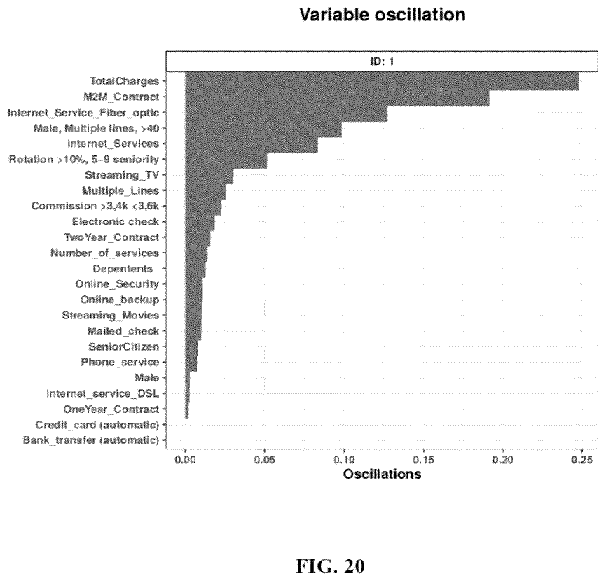

The system and method herein may further provide what-if analysis. In some embodiments, a what-if analysis may be visualized with a Ceteris Paribus plot, such as illustrated in FIG. 19. In the legend below the chart, the shades of color depict, in order of left to right, aggregated Partial Dependency Plot (PDP) and the Ceteris Paribus profile. The Ceteris Paribus plot provides local explanations and enables a user to explore how the individual prediction will change when the values of one variable is changed, as it is easy to track the effect of input variable separately by modifying one variable at a time. In this example, the effect of changes to variable “TotalCharges” on the prediction was plotted. The PDP may show how the expected value of the model prediction behaves as a function of a selected explanatory variable, e.g., by averaging all available Ceteris Paribus profiles, and may provide global explanations. FIG. 20 illustrates a variable oscillation plot which enables a user to find variables which produce the biggest and smallest change in the prediction output when modified. The plot may be based on the fluctuations observed in the Ceteris Paribus profiles (e.g., in FIG. 19). In general, the larger the influence of an explanatory variable on a prediction for a particular instance, the larger the fluctuations on the corresponding Ceteris Paribus profile. A variable that exercises little or no influence on a model's prediction will have a Ceteris Paribus profile that is substantially flat (or otherwise barely change). In other words, the values of the Ceteris Paribus profile can be close to the value of the model's prediction for a particular instance. The oscillation plot may be read as a proxy for feature importance for the local explanation.

Production

A model generated at the model building stage may be readily deployed in the production environment. As described elsewhere herein, data may be collected from various sources and combined into one data set, which can be accessed at any time. Custom-created columns in the data set may be recalculated each time new data is input into the system. After a model is deployed, the system may allow for easy prediction of new observations by automatically updating the custom-created columns upon receiving new data, repreparing the data for prediction by aggregating data from the multiple sources without user intervention. The system may need input on the data to be scored (e.g., analysis name) and the model identifier (ID). The model training operations may be performed independently of prediction and explanation operations.

After calculations, the models can be used in the platform, sent to an internal system, or external system. For example, an external system may function as a control system running a feedback loop. Both predictions and local explanations can be sent to an external system.

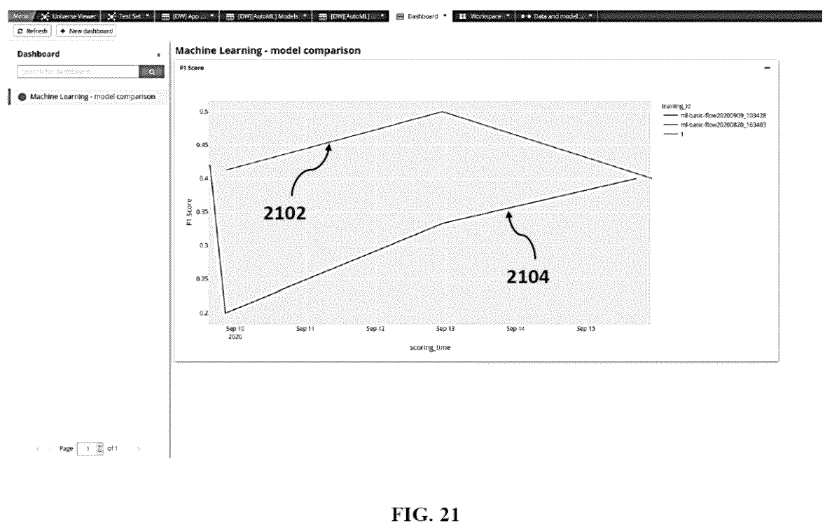

At the production stage, users may validate the model from the system, such as by monitoring scoring metrics, using the XAI functionality (e.g., global and local explanations), evaluating prediction consistency across any subset of the data, monitoring for fairness and ethicality (by selecting the variables that impact such standards), monitoring the performance of models through time, reading histograms and dashboards, etc., as described elsewhere herein. FIG. 21 illustrates an example of model performance monitoring dashboard. Fi score plot comparing the performance of two models through time is presented. It can be seen that the Fi score drops steeply for model 2104. A user reading the plot may be prompted to investigate the data ingested before the prediction date when the plot drops. A user may also conclude that model 2102 generally performed better than model 2104, as it performed more consistently, and decide to select model 2102 over model 2104 during the decision making process.

A method of the present disclosure may comprise one or more operations of data preparation, model building, and production by the model, as described elsewhere herein. For example, a computer-implemented method for end-to-end machine learning may comprise performing data integration and exploratory data analysis of a data set via a user interface presenting a visualization of a database; electing, creating, and/or engineering a feature, or a plurality of features, by creating a calculated column(s) in the data set; providing a target variable and a plurality of explanatory variables to implement an Automated Machine Learning (AutoML) algorithm, to (i) generate and train a model, and (ii) output a global explanation and a local explanation of the model based on the plurality of explanatory variables; using the visualization of the database, filtering the data set for a prediction value of the model, and generating a graphical representation of respective outcome values of at least a subset of the one or more explanatory variables; and subsequent to selection of a model from a plurality of models generated and trained by the AutoML algorithm, deploying the model. In some cases, a graphical representation of respective outcome values of other variables which are connected or otherwise associated to the scored objects, and not necessarily explanatory variables, may be generated.

Database Systems

Provided herein are database systems that may be used with the systems and methods for end-to-end machine learning described herein. The database systems may store the raw data, feature sets, scores, and others as described above. The database systems may provide a user interface for viewing and interacting with the data objects for end-to-end machine learning training. A relational database may be summarized as follows: there are at least two sets of elements and at least one relation that define how elements from a first set are related to elements of a second set. The relation may be defined in a data structure that maps elements of the first set to elements of the second set. Such mapping may be brought about with the aid of unique identifiers (within each set) of the elements in each set. A relational database designer may find it challenging to describe real life events and entities on a very complex tables and relations diagram. Real life events, however, may be suitably defined and presented with the aid of electronic mind maps (also referred to as “mind maps” herein).

In some embodiments, an electronic mind map is a diagram which may be used to visually outline and present information. A mind map may be created around a single object but may additionally be created around multiple objects. Objects may have associated ideas, words and concepts. In some instances, the major categories radiate from each node, and lesser categories are sub-branches of larger branches. Categories can represent words, ideas, tasks, or other items related to a central key word or idea.

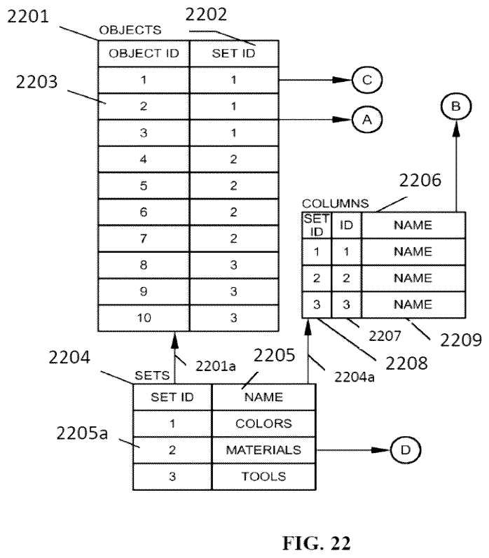

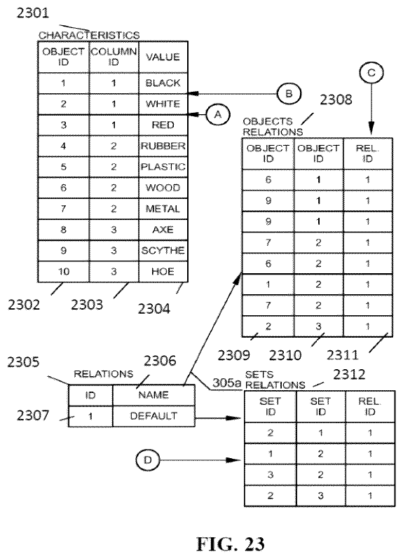

FIG. 22 and FIG. 23 show an example of a database system. In order to cooperate with mind maps, the database system has been designed differently than known database systems. The database system may comprise six data structures and optional data structures. The six data structures may comprise SETS 2204, OBJECTS 2201, COLUMNS 2206, CHARACTERISTICS 2301, RELATIONS 2305 and OBJECTS RELATIONS 2308. The names above are examples and the respective sets may be defined rather by their function within the system than their name.

The first data structure is called SETS 2204 because it may be used to logically hold data related to sets of data. Sets of data may be represented on a mind map as nodes. Each entry in a SETS data structure 2204 may comprise at least a unique identifier 2205a of a data set and may also comprise a name 2205 of the data set. The SETS data structure may be a top level structure and may not refer to other data structures, but other data structures may refer to the SETS data structure as identified by respective arrows between the data structures of FIG. 22.

Each set of data may be, as in the real world, characterized by one or more properties. The second data structure may be called COLUMNS 2206. A property, typically referred to as a “column,” may be uniquely identified with an identifier ID 2207 and may be associated with a data set, defined in the SETS data structure 2204, with the aid of an identifier herein called SET ID 2208. A column may also be associated with a name 2209. As indicated by an arrow 2204a, the COLUMNS data structure may logically, directly reference the SETS data structure 2204, because the COLUMNS data structure may utilize the identifiers of data sets. If, for example, each color of the data set called COLORS comprises another property, such as RGB value, in an example, an entry in the COLUMNS data structure may comprise the following values: ‘1, 4, RGB’. Referring back to an example from FIG. 22, there may be three columns wherein each column is associated with a textual identifier “NAME” 2209.

Objects may form elements of respective data sets in the SETS 2204 data structure and may have properties defined by the COLUMNS 2206 data structure. Objects may be held in the OBJECTS 2201 data structure. The OBJECTS 2201 data structure may hold entries uniquely identified with an identifier ID 2203 and associated with a set, defined in the SETS data structure 2204, with the aid of an identifier herein called SET ID 2202. As indicated by an arrow 2201a, the OBJECTS data structure may logically, directly reference the SETS data structure, as, for example, the SETS data structure utilizes identifiers of sets. Referring back to an example from FIG. 23, there are ten objects in the database, namely three colors, four materials, and three tools. Hence, the OBJECTS data structure 2201 may comprise ten objects.

A fourth data structure, identified as CHARACTERISTICS 2301 in FIG. 23, may hold data entries of each property of each object in FIG. 23. This data structure may be a fundamental difference from known databases in which there are rows of data that comprise entries for all columns of a data table. In the present disclosure, each property of an object is stored as a separate entry, which may greatly improve scalability of the system and allow, for example, the addition of object properties in real time.

The CHARACTERISTICS 2301 data structure may hold entries uniquely identified using an identifier OBJECT ID 2302 and may be associated with a property, defined in the COLUMNS data structure 2206, with the aid of an identifier herein referred to as COLUMN ID 2303. Further, each entry in the CHARACTERISTICS data structure may comprise a value of a given property of the particular object. As indicated by respective arrows originating from sources A and B, the CHARACTERISTICS data structure 2301 may logically, directly reference the COLUMNS data structure and the OBJECTS data structure, because CHARACTERISTICS data structure 2301 uses the identifiers from the respective data structures. CHARACTERISTICS data structure 2301 includes a VALUE property 2304, such as: black, white, red, rubber, plastic, wood, metal, axe, scythe, and hoc.

Referring to an example from FIG. 23, there are ten characteristics that may result from the premise that there are three colors, four materials and three tools. By way of a non-limiting example, one can easily recognize that the BLACK color refers to an object having ID of 1 and a property having ID of 1. By using these identifiers, for example, one may determine that the property description is “NAME” and that the object belongs to the set whose description is “COLORS”.

A fifth data structure, RELATIONS 2305, may function as an operator to hold data regarding relations present in the database. This may be a simple structure and, in principle, may hold an identifier of a relation ID 2307 and additionally hold a textual description of the relation i.e., a NAME 2306. As indicated by an arrow 2305a, the RELATIONS data structure may logically, directly reference (e.g., downwards direction) an OBJECTS RELATIONS data structure 2308, because the OBJECTS RELATIONS may use the identifiers of the relations. While only one entry is illustrated in the RELATIONS data structure, there may be a plurality of types of relations. For example, a type of relation may be indicative of a direction (e.g., unidirectional, bidirectional, etc.) of a relation.

Referring back to mind maps, for example, a relation present in the RELATIONS 2305 data structure, may directly map to a branch between two nodes of a mind map. In some embodiments, as in typical mind maps, a relation may be provided with a textual description.

A sixth data structure may be the OBJECTS RELATIONS data structure 2308. This data structure may be designed to provide mapping between a relation from the RELATIONS data structure 2305 and two objects from the OBJECTS data structure 2201. For example, a first entry in the OBJECTS RELATIONS data structure 2308 defines that a relation having identifier of 1 exists between object having an identifier of 1 and an object having an identifier of 6. This may be an exact definition that a material of wood has a color of black, which is defined across the present relational database system. OBJECT RELATIONS data structure 2308 includes Object ID columns 2309, Object ID column 2310, and Relation ID column 2311.

In some embodiments, a seventh data structure may exist in a database system. This data structure may hold data regarding relations between respective data sets and in FIG. 23 may be referred to as SETS RELATIONS 2312. This data structure may function or operate to provide mapping between a relation from the RELATIONS data structure 2305 and two sets from the SETS data structure 2204. For example, a first entry in the SETS RELATIONS data structure 2312 may define that the relation having identifier of 1 may exist between a set having an identifier of 1 and a set having an identifier of 2. Providing an entry in the SETS RELATION data structure 2312 between a set having an identifier of 1 and a set having an identifier of 2 as well as between a set having an identifier of 2 and a set having an identifier of 1, may allow for creating a bidirectional relation.

There is also a possibility of self-referencing from a given set. For example, such case may be present when there is a set of persons and there exists a student—teacher relation between persons assigned to a particular set. Self-referencing links can be also unidirectional which means that the Entities are bound only in one direction. One can fetch information about linked Entities but cannot refer back to source from the results.

As described, a relational database system of tables may, in one possible example implementation, be stored in the above-described six data structures. In some instances, most of the data may be kept in the OBJECTS and CHARACTERISTICS data structures.

The data structures that are illustrated and described in FIG. 22 and FIG. 23 may also be altered in various ways. For example, in FIG. 22, the OBJECTS data structure can be partitioned or sharded according to SET ID 2202. Sharding, as used herein, may generally refer to horizontal partitioning, whereby rows of database tables may be held separately rather than splitting by columns. Each partition may form part of a “shard,” wherein each “shard” may be located on a separate database server or physical location. Similarly, in FIG. 23, for example, the CHARACTERISTICS data structure can be partitioned or sharded according to COLUMN ID 2303. When sharding is used, for every column in a set, the system may create key value tables that can comprise of the values from the chosen column. The OBJECT RELATIONS table can also be partitioned or sharded according to the REL. ID 2311 or sharded according to an algorithm that can maintain persistence. FIGS. 22 and 23 are for illustration purposes only and may comprise of more columns than is illustrated in those figures.

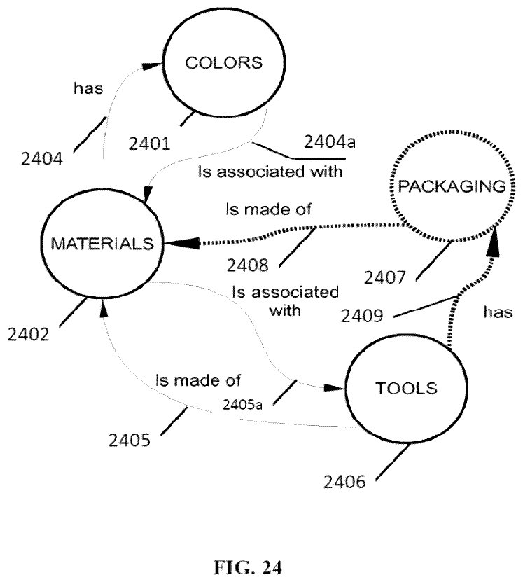

FIG. 24 depicts a mind map that may represent relationships in the database of FIG. 23. There are three nodes that may represent sets of data, namely COLORS 2401, MATERIALS 2402 and TOOLS 2406. A mind map may additionally define branches between respective nodes. Taking into account the relational database which may be defined according to the new database system in FIGS. 22 and 23, there are four branches. A first branch 2404 of the mind map is defined between COLORS 2401 and MATERIALS 2402 and may imply that a MATERIAL may have a COLOR. A second branch 2404a of the mind map may be defined between COLORS 2401 and MATERIALS 2402 and may imply that a COLOR may be associated with a MATERIAL.

Similar to the first two branches, a third branch 2405 of the mind map is defined between MATERIALS 2402 and TOOLS 2406 and may imply that that a TOOL may be made of a MATERIAL. A fourth branch 2405a of the mind map may be defined between MATERIALS 2402 and TOOLS 2406 and may imply that a MATERIAL may be associated with a TOOL.

The relational database may be further expanded to also encompass a possibility that a TOOL may have 2409 a PACKAGING 2407 and the PACKAGING is made of a MATERIAL from MATERIALS 2408.

In some embodiments, because all identifiers may be generated automatically, during creation of the database system of FIGS. 22-23, one may start from the mind map presented in FIG. 24. For each node, a designer may create a name of a set and properties of the objects that may be kept in the set. Similarly, the designer may create branches as relations between respective nodes, such as data sets. Based on such mind map definitions, the system of FIGS. 22-23 may be automatically generated from the mind map of FIG. 24. In particular embodiments, there may additionally be a process of assigning properties to each node of the mind map, wherein each property is an entry in the second data structure, such as the COLUMNS 2206 data structure.

A database structure disclosed herein can be created by a method described as follows. A computer implemented method may store data in a memory and comprise the following blocks, operations, or actions. A first data structure may be created and stored in a memory, wherein the first data structure may comprise a definition of at least one data set, wherein each data set comprises a data set identifier and logically may hold data objects of the same type. Next, a second data structure may be created and stored in the memory, wherein the second data structure may comprise definitions of properties of objects, wherein each property may comprise an identifier of the property and an identifier of a set to which the property is assigned.

Further, a third data structure may be created and stored in the memory, wherein the third data structure may comprise definitions of objects, and wherein each object comprises an identifier and an identifier of a set the object is assigned to. A fourth data structure may be created and stored in the memory, wherein the fourth data structure may comprise definitions of properties of each object, and wherein each property of an object associates a value with an object and a property of the set to which the object is assigned. A fifth data structure may be created and stored in the memory, wherein the fifth data structure may comprise definitions of relations, and wherein each relation comprises an identifier of the relation. Finally, a sixth data structure may be created and stored in the memory, wherein the sixth data structure may comprise definitions of relations between objects wherein each objects relation associates a relation from the fifth data structure to two objects from the third data structure.

In accordance with the database system of the present disclosure, a process of adding an object (a record) to the database may be outlined as follows. First a new entry may be created in the OBJECTS data structure 2201. The object may be assigned to a given data set defined by the SETS data structure 2204. For each object property of the given set defined in the COLUMNS data structure 2206, there may be created an entry in the CHARACTERISTICS data structure 2301. Subsequently there may be created relations of the new object with existing objects with the aid of the OBJECTS RELATIONS data structure 2308.

A method of removing objects from the database system is described below. First, an object to be removed may be identified and its corresponding unique identifier may be fetched. Next, any existing relations of the object to be removed with other existing objects may be removed by deleting entries in the OBJECTS RELATIONS data structure 2308 that are related to the object being removed. Subsequently, the object entry may be removed from the OBJECTS data structure 2201. The object may be removed from a given data set defined by the SETS data structure 2204. Because the properties of each object are stored separately, for each object property of the given set defined in the COLUMNS data structure 2206, there is removed an entry in the CHARACTERISTICS data structure 2301 related to the object identifier being removed from the database.

A method for creating the database system using a mind map is provided. The first step may be to create a mind map structure. Defining a database system using a mind map may be beneficial and allow a designer to more easily see the big picture in very complex database arrangements. A designer may further be able to visualize the organization of data sets and relations that may exist between the respective data sets. Next, a new node may be added to the mind map structure. This may typically be executed via a graphical user interface provided to a database designer. A node of a mind map may represent a set as defined with reference to FIG. 22. Therefore, it may be advantageous at this point to define, preferably using the graphical user interface, properties associated with the data set associated with this particular node of the mind map. Then, a record or entry may be stored in the first and second data structures, which are the SETS data structure 2204 and COLUMNS data structure 2206 of FIG. 22, respectively.

The next step may be to create a branch within the mind map. A branch may start at a node of the mind map and end at the same node of the mind map to define a self-relation. For example, there may be a set of users for which there exists a hierarchy among users. Alternatively or in addition to, a branch may start at a node of the mind map and end at a different node, for example, of the mind map to define a relation between different nodes, i.e., different sets of objects of the same kind.

The following operations may be executed to store a record in the fifth data structure, which is the RELATIONS data structure 2305 of FIG. 23. At least one object can be added to existing data sets, i.e., nodes of the mind map. In some embodiments, a way of adding objects to mind map nodes may be by way of a graphical user interface with one or more graphical elements representing nodes and connections among the nodes. For example, by choosing an option to add an object, a user may be presented with a set of properties that may be set for the new object. The properties may be defined in the COLUMNS data structure 2206 of FIG. 22. After the user provides an input, an object may be added to the selected node of the mind map by storing one or more records in the third, fourth, and sixth data structures that are the OBJECTS data structure 2201, the CHARACTERISTICS data structure 2301 and OBJECTS RELATIONS data structure 2308 of FIGS. 22 and 23, respectively.

Databases of the present disclosure may store data objects in a non-hierarchical manner. In some cases, such databases may enable database queries to be performed without the need of joins, such as inner or outer joins, which may be resource intensive. This may advantageously improve database queries.

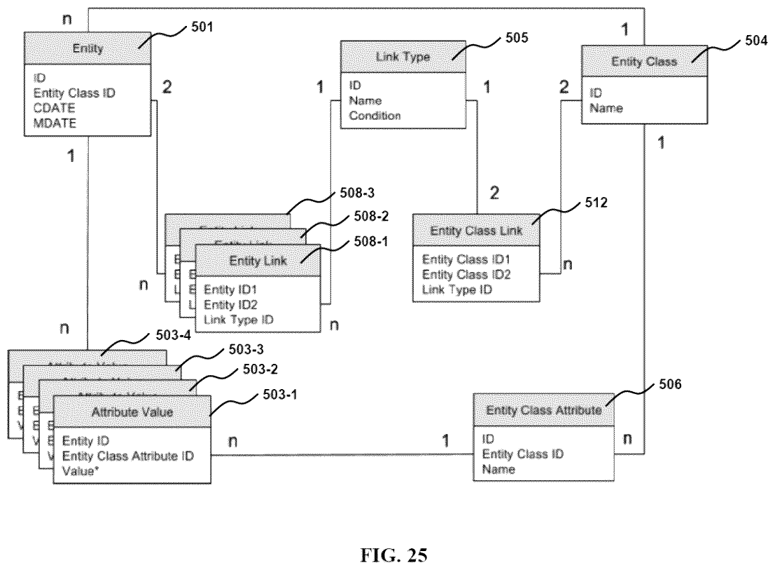

In an example, FIG. 25 shows a model of a database system of the present disclosure. The model may be similar to, or correspond to, the examples of the database systems described in FIG. 22 and FIG. 23. The model may comprise a set of predefined data structures. In the illustrated model, the Entity data structure 501 may correspond to the OBJECTS data structure 2201. Similarly, the Entity data structure may hold entries uniquely identified with an identifier ID (e.g., ID) and associated with an entity class, defined in the Entity Class data structure 504, with the aid of an identifier herein called Entity Class ID. The Entity data structure 501, in some embodiments, may further comprise a timestamp corresponding to the date and time an object is created (e.g., CDATE) and/or date and time an object is last modified (e.g., MDATE).

The Entity Class data structure can correspond to the SETS data structure 2204 as described in FIG. 22. Similarly, the Entity Class data structure may hold data related to Entity Class data. Classes of data may be represented on a mind map as nodes. Each entry in an Entity Class data structure 504 may comprise at least a unique identifier (e.g., ID) and may also comprise its name (e.g., Name). For each entity property of the given entity class defined in the Entity Class Attribute data structure 506, there may be created an entry in the Attribute Value data structure 503-1, 503-2, 503-3, 503-4. Subsequently there may be created relations of the new object with existing objects with the aid of the Entity Link data structure 508-1, 508-2, 508-3.

The Entity Class Attribute data structure 506 can correspond to the COLUMNS data structure 2206 as described in FIG. 22. Similarly, the Entity class Attribute data structure 506 may hold entries uniquely identified with an identifier ID (e.g., ID) that is associated with an entity class, defined in the Entity Class data structure 504, with the aid of the Entity Class ID, and the name of the attribute (e.g., Name). The Attribute Value data structure 503-1, 503-2, 503-3, 503-4 may correspond to the CHARACTERISTICS data structure 2301 as described in FIG. 23, except that the Attribute Value data structure may use multiple tables 503-1, 503-2, 503-3, 503-4 to hold entries uniquely identified using an identifier (e.g., Entity ID), a property defined in the Entity class Attribute data structure 506, with the aid of an identifier (Entity Class Attribute ID) and a value of a given property of the particular entity (e.g., Value). In some cases, the multiple tables may collectively hold the attribute values with each table storing a portion of the data.

The Entity Link data structure 508-1, 508-2, 508-3 can correspond to the OBJECTS RELATIONS data structure 2308 as described in FIG. 23 with the exception that multiple tables 508-1, 508-2, 508-3 may be used to collectively hold data related to relations or connections between two entities. Similarly, an entry of the Entity Link data structure may comprise two entity IDs (e.g., Entity IDI, Entity ID2) and the identifier of the Link Type (e.g., Link Type ID) between the two entities. The Link Type identifier may reference from the Link Type data structure 505.

The Link Type data structure 505 can correspond to the RELATIONS data structure 2305 as described in FIG. 23. Similarly, the Link Type data structure 505 may hold an identifier of a link type ID (e.g., ID) and additionally hold a textual description of the link (e.g., NAME). In some cases, the link type can define a permission level of accessing the connection between entities or entity classes. For example, the link type may be a private type link that only the user who creates the link or the system administer can view or modify, or a public type link that can be viewed or defined by any user. For instance, an administrator or certain users with privileges may configure a link to be visible to other users. In this case, the administrator may decide to “publish” the link, which may enable the link to be available to the public, thereby converting the link type from private to public. Alternatively or in addition to, a link type may have various other permission levels or editable privileges that are provided by the system.

Computer Systems

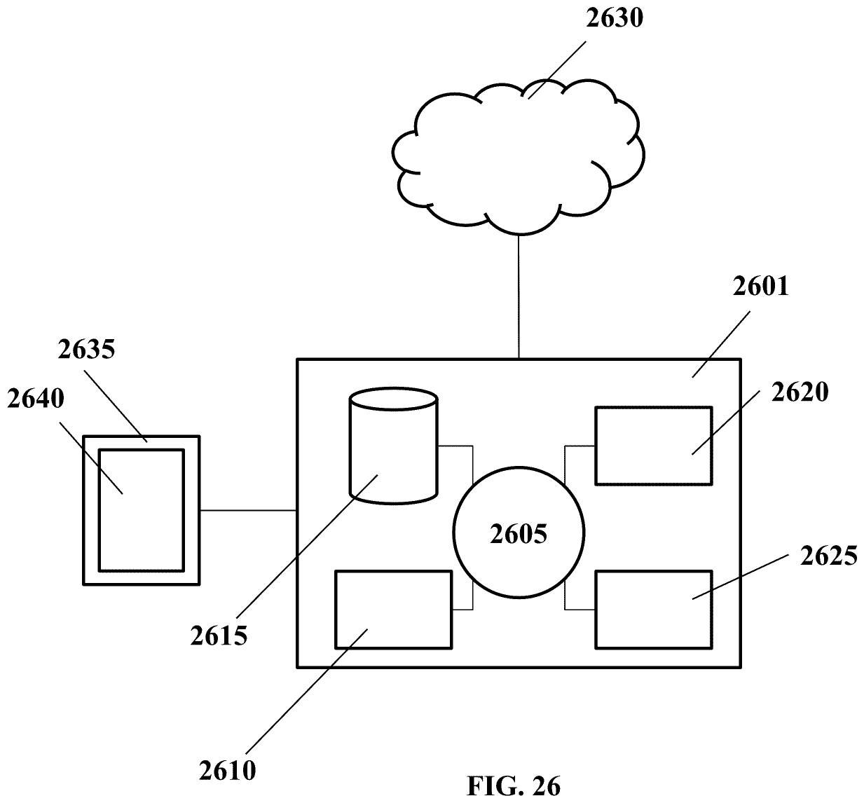

The present disclosure provides computer systems that are programmed to implement methods of the disclosure. FIG. 26 shows a computer system 2601 that is programmed or otherwise configured to apply a search path to various data models, perform filter operations and analyses on data sets, create and analyze features, generate explanations and visual plots, run one or more algorithms (e.g., machine learning algorithms), and perform various operations described herein. The computer system 2601 can regulate various aspects of visualization, queries and graph analysis of the present disclosure. The computer system 2601 can be an electronic device of a user or a computer system that is remotely located with respect to the electronic device. The electronic device can be a mobile electronic device.

The computer system 2601 includes a central processing unit (CPU, also “processor” and “computer processor” herein) 2605, which can be a single core or multi core processor, or a plurality of processors for parallel processing. The computer system 2601 also includes memory or memory location 2610 (e.g., random-access memory, read-only memory, flash memory), electronic storage unit 2615 (e.g., hard disk), communication interface 2620 (e.g., network adapter) for communicating with one or more other systems, and peripheral devices 2625, such as cache, other memory, data storage and/or electronic display adapters. The memory 2610, storage unit 2615, interface 2620 and peripheral devices 2625 are in communication with the CPU 2605 through a communication bus (solid lines), such as a motherboard. The storage unit 2615 can be a data storage unit (or data repository) for storing data. The computer system 2601 can be operatively coupled to a computer network (“network”) 2630 with the aid of the communication interface 2620. The network 2630 can be the Internet, an internet and/or extranet, or an intranet that is in communication with the Internet. The network 2630 in some cases is a telecommunication and/or data network. The network 2630 can include one or more computer servers, which can enable distributed computing, such as cloud computing. The network 2630, in some cases with the aid of the computer system 2601, can implement a peer-to-peer network, which may enable devices coupled to the computer system 2601 to behave as a client or a server.

The CPU 2605 can execute a sequence of machine-readable instructions, which can be embodied in a program or software. The instructions may be stored in a memory location, such as the memory 2610. The instructions can be directed to the CPU 2605, which can subsequently program or otherwise configure the CPU 2605 to implement methods of the present disclosure. Examples of operations performed by the CPU 2605 can include fetch, decode, execute, and writeback.

The CPU 2605 can be part of a circuit, such as an integrated circuit. One or more other components of the system 2601 can be included in the circuit. In some cases, the circuit is an application specific integrated circuit (ASIC).

The storage unit 2615 can store files, such as drivers, libraries and saved programs. The storage unit 2615 can store user data, e.g., user preferences and user programs. The computer system 2601 in some cases can include one or more additional data storage units that are external to the computer system 2601, such as located on a remote server that is in communication with the computer system 2601 through an intranet or the Internet.

The computer system 2601 can communicate with one or more remote computer systems through the network 2630. For instance, the computer system 2601 can communicate with a remote computer system of a user (e.g., a webserver, a database server). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 2601 via the network 2630.

Methods as described herein can be implemented by way of machine (e.g., computer processor) executable code stored on an electronic storage location of the computer system 2601, such as, for example, on the memory 2610 or electronic storage unit 2615. The machine executable or machine readable code can be provided in the form of software. During use, the code can be executed by the processor 2605. In some cases, the code can be retrieved from the storage unit 2615 and stored on the memory 2610 for ready access by the processor 2605. In some situations, the electronic storage unit 2615 can be precluded, and machine-executable instructions are stored on memory 2610.

The code can be pre-compiled and configured for use with a machine have a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 2601, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 2601 can include or be in communication with an electronic display 2635 that comprises a user interface (UI) 2640 for providing, for example, visualization. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 2605.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A computer-implemented method for end-to-end machine learning process, comprising:
(a) performing exploratory data analysis of a data set via a user interface presenting a visualization of a database and identifying a plurality of explanatory variables;
(b) selecting or creating a feature by creating a calculated column in the data set;
(c) training a model using an Automated Machine Learning (AutoML) algorithm based at least in part on the feature in (b) and the plurality of explanatory variables;
(d) outputting a global explanation and a local explanation of the model based on the plurality of explanatory variables and a target variable to determine whether to accept or reject the model for production;
(e) upon rejecting the model, repeating (b)-(d) until a model is accepted as a production model; and
(f) deploying and monitoring the performance of the production model.

2. The computer-implemented method of claim 1, wherein the visualization of the database comprises a graph with each entity class of the data set depicted as a node and connections between entity classes depicted as links.

3. The computer-implemented method of claim 1, wherein the user interface provides a histogram panel displaying a histogram of an explanatory variable selected from the plurality of explanatory variables.

4. The computer-implemented method of claim 1, wherein the feature is created by performing an analysis of the data set.

5. The computer-implemented method of claim 4, wherein the analysis comprises one or more filtering operations performed on the data set.

6. The computer-implemented method of claim 4, wherein the calculated column comprises scores produced by the analysis.

7. The computer-implemented method of claim 1, wherein the feature is created via the user interface by inputting a custom query.

8. The computer-implemented method of claim 1, wherein the feature is created via the user interface by specifying a condition for assigning a value to the feature.

9. The computer-implemented method of claim 1, wherein the AutoML algorithm comprises searching a plurality of available models and selecting the model based on one or more performance metrics.

10. The computer-implemented method of claim 1, further comprising using the visualization of the database, filtering the data set for a prediction value of the model, and generating a graphical representation of respective outcome values of one or more of variables, including at least a subset of the one or more explanatory variables.

11. The computer-implemented method of claim 1, wherein the global explanation comprises a reason the model provided incorrect predictions, invalid data or outliers in the data set, or extraction of knowledge about the data set.

12. The computer-implemented method of claim 1, wherein the local explanation comprises model consistency across different subsets of the data set, or a contribution of one or more explanatory variables to a prediction output of the model.

13. The computer-implemented method of claim 1, wherein the user interface provides a dashboard panel for monitoring and comparing the performance of the production model across time.

14. The computer-implemented method of claim 12, wherein the local explanation comprises information about how the prediction output of the model changes based on a change in the one or more explanatory variables.

15. A non-transitory computer-readable medium comprising machine-executable code that, upon execution by one or more computer processors, implements a method comprising:
(a) performing exploratory data analysis of a data set via a user interface presenting a visualization of a database and identifying a plurality of explanatory variables;
(b) selecting or creating a feature by creating a calculated column in the data set;
(c) training a model using an Automated Machine Learning (AutoML) algorithm based at least in part on the feature in (b) and the plurality of explanatory variables;
(d) outputting a global explanation and a local explanation of the model based on the plurality of explanatory variables and a target variable to determine whether to accept or reject the model for production;
(e) upon rejecting the model, repeating (b)-(d) until a model is accepted as a production model; and
(f) deploying and monitoring the performance of the production model.

16. The non-transitory computer-readable medium of claim 15, wherein the visualization of the database comprises a graph with each entity class of the data set depicted as a node and connections between entity classes depicted as links.

17. The non-transitory computer-readable medium of claim 15, wherein the user interface provides a histogram panel displaying a histogram of an explanatory variable selected from the plurality of explanatory variables.

18. The non-transitory computer-readable medium of claim 15, wherein the feature is created by performing an analysis of the data set.

19. The non-transitory computer-readable medium of claim 18, wherein the analysis comprises one or more filtering operations performed on the data set

20. The non-transitory computer-readable medium of claim 18, wherein the calculated column comprises scores produced by the analysis.
